(19) United States
(12) Patent Application Publication
(10) Pub. No.: US 2010/0139159 A1
(43) Pub. Date: Jun. 10, 2010

(54) APPARATUS AND METHOD FOR THE APPLICATION OF SOIL CONDITIONERS

(75) Inventor: Dietmar Plate, Northeim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Stockhausen Gmbh, Krefeld (DE)

(21) Appl. No.: 12/594,350

(22) PCT Filed: Apr. 4, 2008
(86) PCT No.: PCT/EP2008/002694

§ 371 Date: Oct. 2, 2009

(30) Foreign Application Priority Data
Apr. 5, 2007 (DE) 10 2007 016 919.3

(51) Int. Cl. A01G 1/00

(52) U.S. Cl. 47/58.1 SC

(57) ABSTRACT

The invention relates to a method for ground cultivation, in particular of green spaces and existing areas of vegetation, comprising the following steps:
a.) production of a conveyable application form of a soil conditioner in which the soil conditioner is present as a dispersion of pre-swollen particles and/or as hydrogel;
b.) conveyance of the application form of the soil conditioner produced in step a.) to a depositing device;
c.) depositing of the soil conditioner by means of a depositing device, and a device for carrying out such a cultivation method.

The invention relates to an apparatus and to a method for introducing soil conditioners.

The intensive utilization of a vegetation area—here in particular a turf area—and the necessary maintenance measures often lead to turf wear, especially to the joining of the solid microparticles in the soil. This compaction arises through a reduction of the large or macroporous spaces, or else also of the pore spaces in the soil as a whole. This reduces water infiltration, seepage and drainage in the soil, destroys the capillary action and limits the exchange of the soil gases, especially soil oxygen, with the atmosphere. Moreover, this leads to a reduction in root growth and hence to inadequate development of the turf; for example, in some cases, a substantial reduction in the root system and often also dying of the deeper roots is caused.

The suitable cultivation of vegetation areas, for example turf, in order especially to bring about drainage but also strong root growth, and in order to improve the soil-air-water ratio, has always been a problem in gardening including landscape gardening, and manufacturers of agricultural machinery in the past have built and tested a large number of apparatuses in order to find a solution to this problem.

Core cultivation (aerification) is widespread as a long-term program for reducing compacted conditions in the soil root zone. Various different types of core cultivation machines are commercially available for this purpose.

However, it has been found that the use of such cultivation machines over a long period leads to compaction of the soil below the layer processed, i.e. of the subsoil. These compacted lower soil layers firstly disrupt the desired water circulation in the soil and secondly the desired root growth of the vegetation areas or of the turf.

To solve this problem of subsoil cultivation, EP 0 627 158 proposed a cultivation apparatus which injects essentially incompressible liquids into the soil by means of a sufficient pressure, in order thus to break up the compacted soil layers. Incompressible liquids i.e. incompressible newtonian fluids or else hydraulic fluids, mentioned explicitly are water or liquid fertilizers and weedkillers.

Even though apparatus as described, for example, in EP 0 627 158 provide very good results in soil aeration and as a result bring about improved water absorption of the soil, they do not enable any measures which lead to permanent water and nutrient storage in the soil. A disadvantage is especially that, in the case of performance of the cultivation according to EP 0 627 158, when the products are injected in aqueous form, sludge components present in the soil, so-called fines with a particle size below 0.1 mm, are deposited permanently in the lower part of the injection balloon and thus bring about closure of the subsoil, and so the capillary structure of the soil is not preserved.

Measures which lead to permanent water and nutrient storage in the soil are especially the introduction of soil conditioners in the form of water-swellable polymers, which can be used advantageously, for example, as soil auxiliaries for water and nutrient storage, and as root protection gels. By way of example, reference is made here to U.S. Pat. No. 5,303,663, in which a method for promoting plant growth in soils is described and water-absorbable or water-swellable polymer particles are incorporated into the soil in dry form. Such soil conditioners for agriculture or farming, forestry and gardening are likewise sold, for example, by Stockhausen GmbH, Krefeld under the STOCKOSORB® brand name.

These soil conditioners are introduced into the soil whenever, owing to the soil properties or owing to climatic conditions, the water and nutrient storage is insufficient. For example, water and nutrient storage in sandy and pervious soils is extremely limited, because the rainwater and irrigation water drains away for the most part unutilized by the plants, and/or evaporates too rapidly through the normal capillaries. Furthermore, the nutrients are washed out of the root region very easily.

In principle, however, the amount of plant-available water is one factor in deciding the quality of plant growth. Nonetheless, the water supply of plants is subject to great variations. For example, precipitation deficits and dry periods ensure that the water content in the soil rapidly falls below the minimum amount required for growth. In order to prevent drought damage and plant failures, intensive irrigation is then necessary, which is labor-intensive. Especially in the dry zones of the earth, irrigation measures are exceptionally costly owing to the scarcity of the natural water resources to be found there. In order to be able effectively to practice agriculture or farming, forestry and gardening, for example in the form of landscape management and maintenance in green areas of hotels and golf courses, lawns and equestrian facilities, etc. in such dry zones, which are frequently also holiday regions, there is therefore a need for sophisticated water management, since up to 50% of the water often evaporates before it reaches the roots of the plants.

One disadvantage of the use of those water-swellable soil conditioners as described, for example, in the aforementioned U.S. Pat. No. 5,303,663, or the water-swellable polymers sold under the STOCKOSORB® brand name from Stockhausen GmbH, Krefeld was the fact that, especially in golf areas and all other vegetation areas and lawns, the areas cannot be played upon immediately after the application of these compositions, which was a barrier to application of these incidentally very advantageous soil conditioners. Furthermore, it was observed in practice that the incorporation of these water-swellable soil conditioners in dry form was exceptionally difficult, or the incorporation into the soil was only very inhomogeneous and led to destabilization of the soil. This resulted directly in a change to the original relief of the vegetation area. Such a change to the soil relief is, however, completely unacceptable for sports pitches and golf courses.

There is thus a need for a cultivation method, especially for green areas, and vegetation cover already present, which firstly ensures effective soil aerification without this changing the original relief of the vegetation area, and secondly leads to permanent water and nutrient storage in the soil, and to an apparatus for introducing soil conditioners to implement such a cultivation method.

It was therefore an object of the invention to develop such a process, which ensures a permanent increase in the utilizable water capacity of soils or of the plant-available amount of water, and leads to a significant reduction in irrigation frequency, and simultaneously ensures homogeneous water supply of plants and more rapid and better root development, including a reduction in the nutrient discharge to the groundwater thus bringing about a reduction in cost for irrigation and fertilization, and to provide an apparatus for implementing such a cultivation method.

Completely surprisingly, a cultivation method has been found, especially for existing green areas and existing vegetation areas, comprising the steps of
a.) producing a deliverable application form of a water-swellable soil conditioner, in which the soil conditioner is present as a dispersion of pre-swollen particles and/or as a hydrogel,
b.) delivering the application form of the soil conditioner produced in step a.) to an introduction apparatus,
c.) introducing the soil conditioner by means of the introduction apparatus.

According to the invention, useable soil conditioners include all compositions which may find use in the form of a deliverable application form, preferably as a dispersion and, more preferably in accordance with the invention, as hydrogels, in agriculture or farming and gardening, for example as soil auxiliaries for water and nutrient storage, and also in synthetic soil for plant breeding, and as root protection gels.

It is essential to the invention, however, that the deliverable application form of the soil conditioner is not introduced in dry form into the soil or vegetation area to be cultivated, but the water-swellable soil conditioners are instead pre-swollen, such that they are present as a dispersion of pre-swollen particles and/or as a hydrogel.

In a preferred embodiment of the invention, the soil conditioner is at least one water-insoluble crosslinked polymer which forms a three-dimensional polymeric network and is capable of absorbing large amounts of water or aqueous liquids with swelling and formation of hydrogels, and of being able to retain the amount of liquid absorbed even under the action of an external pressure, for example all crosslinked poly(meth)acrylates which contain carboxylate groups and can form hydrogels. In addition, the absorbent polymers here may also be water-swellable polymers based on natural substances, for example polysaccharides, alginates, pectins, gelatins, guar, carboxymethylcellulose, etc., or water-swellable or hydrogel-forming polymers based on synthetic substances such as acrylic acid, methacrylic acid, acrylamide, acrylonitrile, styrene and derivatives thereof.

In particular, suitable poly(meth)acrylates containing carboxylate groups for use in accordance with the invention are those which are formed primarily and preferentially from the monomers acrylic acid, acrylamide, methacrylic acid and methacrylamide, but additionally also other water-soluble monomers, such as acrylonitrile, methacrylonitrile, N,N-dimethylacrylamide, vinylpyridine and further water-soluble polymerizable acids and salts thereof, especially maleic acid, fumaric acid, itaconic acid, vinylsulfonic acid, or acrylamidomethylpropanesulfonic acid; and also hydroxyl-containing esters of polymerizable acids, especially the hydroxyethyl and hydroxypropyl esters of methacrylic acid; and additionally amino-containing and ammonium-containing esters and amides of polymerizable acids such as the dialkylamino esters, especially the dimethyl- and the diethylaminoalkyl esters of acrylic acid and of methacrylic acid, and the trimethyl- and trimethylammonioalkyl esters and the corresponding amides.

The poly(meth)acrylates for use in accordance with the invention may be formed exclusively from aforementioned carboxylate-containing monomers or else be combined in a copolymer with the monomers bearing no carboxylate groups. In the copolymers, the proportion of the carboxylate monomers is 90 to 10 mol %, preferably 60 to 30 mol %.

It is also additionally possible for slightly or completely water-insoluble monomers to be copolymerized in small amounts with the above monomers, for instance vinyl esters and the esters of acrylic acid and/or methacrylic acid with C₁-C₁₀-alcohols, styrene and alkylated styrene. In general, the proportion of the water-soluble monomers is 80 to 100% by weight, based on the entirety of the monomers. The water-insoluble (hydrophobic) monomers generally make up 0 to 20% by weight of the monomers.

The acidic monomer constituents can be neutralized before the polymerization, the degree of neutralization preferably being between 10 and 95 mol %, especially between 50 and 90 mol %, and especially between 70 and 95 mol %. Useful bases for the neutralization include all common inorganic and organic compounds; preference is given especially to sodium hydroxide solution, potassium hydroxide solution and ammonia or ammonium hydroxide.

Together with the abovementioned monomers, crosslinking monomers with more than one reactive group in the molecule are also polymerized in small proportions. This forms partly crosslinked polymers which are no longer water-soluble, but only water-swellable.

Examples of crosslinking monomers include bi- or polyfunctional monomers, for example amides such as methylenebisacrylamide or -methacrylamide or ethylenebisacrylamide, and also allyl compounds such as allyl (meth)acrylate, alkoxylated allyl (meth)acrylate reacted with preferably 1 to 30 mol of ethylene oxide, triallyl cyanurate, diallyl maleate, polyallyl esters, tetraallyloxyethane, triallylamine, tetraallylethylenediamine, allyl esters of phosphoric acid or phosphorous acid, and also crosslinkable monomers, such as the N-methylol compounds of amides such as methacrylamide or acrylamide and the ethers derived therefrom, and also esters of polyols and alkoxylated polyols, such as diacrylates or triacrylates, for example butanediol diacrylate or ethylene glycol diacrylate, polyglycol di(meth)acrylates, trimethylolpropane triacrylate, di- and triacrylate esters of trimethylolpropane which has preferably been alkoxylated (ethoxylated) with 1 to 30 mol of alkylene oxide, acrylate and methacrylate esters of glycerol and pentaerythritol, and of glycerol and pentaerythritol which have been ethoxylated with preferably 1 to 30 mol of ethylene oxide.

Preference is given to using methylene- or ethylenebis(meth)acrylamide, N-methylolacrylamide and triallylamine. The proportion of the crosslinking comonomers is 0.01 to 2.5% by weight, preferably 0.01 to 1.0% by weight and more preferably 0.01 to 0.1% by weight, based on the entirety of the monomers.

The carboxylate-containing polymers for use in accordance with the invention may contain water-soluble polymers as a graft base, preference being given to amounts up to 30% by weight. These include partly or fully hydrolyzed polyvinyl alcohols, starch or starch derivatives, cellulose or cellulose derivatives, lignin or lignin derivatives, polyacrylic acids, polyglycols or mixtures thereof.

In a further embodiment of the invention, the polymers for use may be postcrosslinked. For the postcrosslinking, which leads to a significant improvement in the gel stability, in the liquid absorption under pressure and in the absorption rate, the compounds used generally possess at least two functional groups and can crosslink the functional groups of the polymer at the surface of the polymer particles. Preference is given to alcohol, amine, aldehyde, glycidyl and epichloro functions, and it is also possible to use crosslinker molecules with a plurality of different functions.

Examples include the following postcrosslinking agents: ethyl glycol, diethylene glycol, triethylene glycol, polyethylene glycol, glycerol, polyglycerol, propylene glycol, diethanolamine, triethanolamine, polypropylene oxide, block copolymers of ethylene oxide and propylene oxide, sorbitan fatty acid esters, ethoxylated sorbitan fatty acid esters, ethoxylated sorbitan fatty acid esters, trimethylolpropane, ethoxylated trimethylolpropane, pentaerythritol, ethoxylated pentaerythritol, polyvinyl alcohol, sorbitol, ethylene carbonate, propylene carbonate and polyepoxides, for instance ethylene glycol diglycidyl ether.

Preference is given to working with ethylene carbonate as the postcrosslinking agent. The postcrosslinking agent is used in an amount of 0.01 to 10% by weight, preferably 0.1 to 5% by weight, more preferably 0.1 to 1% by weight based on the polymer to be postcrosslinked.

The preparation of the poly(meth)acrylates for use in accordance with the invention can be performed by customary methods; preference is given to polymerizing in aqueous solution batchwise in a polymerization vessel, or continuously, for instance on a continuous belt. The polymerization is triggered with customary initiators or redox systems which trigger a free-radical polymerization. In the case of a virtually adiabatic profile of the polymerization, with an appropriate starting concentration of 15 to 50% by weight of the monomers, an aqueous polymer gel forms. The selection of the starting monomer concentration and of the corresponding low start temperature within the temperature range from 0 to 50° C., preferably from 5 to 25° C., allows the polymerization to be conducted in such a way that the maximum temperature in the aqueous polymer gel which forms can be controlled efficiently. After the polymerization has ended, the polymer gel is comminuted mechanically, dried, ground and optionally subjected to surface crosslinking.

In addition, the suspension polymerization method is also suitable for preparing the poly(meth)acrylates in which the discrete polymer particles are formed as early as during the polymerization.

In the course of addition of surface postcrosslinking agents, thorough mixing of the polymer particles should be ensured. Suitable mixing units for applying the postcrosslinking agent are, for example Patterson-Kelley mixers, DRAIS turbulent mixers, Lodige mixers, Ruberg mixers, screw mixers, pan mixers and fluidized bed mixers and continuous upright mixers in which the powder is mixed in rapid frequency by means of rotating blades (Schugi mixer). Once the postcrosslinking agent, preferably in the form of a solution, has been mixed with the polymer particles, the postcrosslinking reaction is performed by heating to temperatures of 80 to 250° C., preferably to 135 to 250° C. and more preferably to 150 to 200° C. The optimal duration of the postheating can be determined easily with a few tests for the individual crosslinker types. It is limited by the point at which the desired profile of properties of the superabsorbent is destroyed again owing to heat damage. For example, the crosslinking times for temperatures of 180° C. are usually below 30 minutes.

The poly(meth)acrylates may further comprise processing and conditioning aids, for example, potassium stearate, polyglycol, silicas, bentonites.

The residual monomer content of the poly(meth)acrylates for use in accordance with the invention is low and is less than 1000 ppm, for example less than 250 ppm. More particularly, the residual content of ecotoxicologically harmful monomers, for example acrylamide, is less than 250 ppm, preferably less than 100 ppm or more preferably less than 50 ppm.

The absorption capacity of the poly(meth)acrylates for use in accordance with the invention for water and aqueous solutions may vary within wide limits and is adjusted by means of the monomer constituents, the crosslinking agents and if appropriate the postcrosslinking agents.

Preference is given to using those poly(meth)acrylates which absorb more than 30 g/g, preferably more than 50 g/g and more preferably more than 65 g/g of polymer of a synthetic soil solution with a conductivity of 2.5 μS. The synthetic soil solution contains, per 10 l of water, 0.71 g of NaCl, 0.065 g of NaN₃, 1.676 g of KCl, 0.353 of NH₄Cl, 3.363 g of MgCl₂×6H₂O, 10.5 g CaCl₂×2H₂O and 0.019 g of FeCl₃×6H₂O. 1 g of poly(meth)acrylate is stirred in 200 ml of this solution with a magnetic stirrer for 15 min, left to stand for 45 min and then filtered through a 100 mesh sieve. The quotient of the amount of liquid absorbed and the starting weight of polymer gives the absorption value.

Poly(meth)acrylate copolymers which have been prepared using carboxylate-free comonomers, especially acrylamide, possess a higher long-term stability of absorption with respect to frequently alternating moist and dry phases during use.

The soluble fractions of the poly(meth)acrylates for use in accordance with the invention are typically less than 20% by weight, preferably less than 15% by weight and most preferably less than 10% by weight.

The particle size of the polymers for use in the process according to the invention may be different according to the application; it is typically in the range from 0.2 to 3 mm.

In a further embodiment of the invention, the poly(meth)acrylates may be laden with active ingredients which they release again to the environment in a retarded manner in the course of the inventive use. These active ingredients include fertilizers, herbicides and pesticides.

According to the invention, particularly preferred soil conditioners are those soil conditioners for agriculture or farming, forestry and gardening, which are sold by Stockhausen GmbH, Krefeld under the STOCKOSORB® brand name. These are water-swellable, especially superabsorbent, polymers which are obtainable by polymerizing the above-described components, especially by
a.) 55 to 99.95% by weight of monomers which bear monoethylenically unsaturated carboxyl groups and are optionally partially neutralized
b.) 0.05 to 5.0% by weight of at least one crosslinker,
c.) 0 to 40% by weight of further monomers copolymerizable with a.),
d.) 0 to 30% by weight of a water-soluble grafting base, and the constituents a.) to d.) add up to 100% by weight.

To produce the deliverable application form of the soil conditioner for use in step a.), the soil conditioner, preferably in the form of a water-swellable polymer, for example STOCKOSORB® granule, is introduced into a vessel in which a portion of at least one delivery agent or dispersant, typically water, is initially charged, and the soil conditioner is introduced into the vessel with intensive stirring, the remaining amount of the delivery agent or dispersant (water) being supplied simultaneously. It is also possible to initially charge the entire amount of the delivery agent or dispersant and then to mix the soil conditioner in the vessel. However, it is of great importance that the soil conditioner is mixed homogeneously in the delivery agent or dispersant, i.e. is present as a homo-geneous suspension or dispersion, such that it can be applied to the soil of the vegetation area to be cultivated. More preferably in accordance with the invention, the soil conditioner is present in the form of a hydrogel after the mixing operation.

The mixing ratio of soil conditioner in weight in relation to the delivery agent or dispersant used is in the range from 0.5:100 to 1:20. Preferred mixing ratios are in the range from 1:100 to 1:50, especially 1:80 or 1:60.

In step b.), the deliverable application form of the soil conditioner produced in step a.) is transferred by means of a delivery apparatus, preferably a pump apparatus, to an introduction apparatus.

Preferably in accordance with the invention, this is an introduction apparatus which works mechanically, hydraulically or with air pressure and has injection nozzles and/or metallic hollow rods or hollow tines for introduction of the soil conditioner, which are at a defined distance from one another and ensure homogeneous distribution of the soil conditioner; preferably 300 to 900 injection sites per m² of grass or turf area should be guaranteed. Moreover, the introduction apparatus must be capable of introducing the soil conditioner to the depth required for soil cultivation, especially into the main root zone in green areas, preferably down to a depth of 3 cm to 25 cm.

The introduction apparatus preferably comprises a pressure apparatus, especially in the form of an injection unit for introducing the soil conditioner into the soil (soil injection unit).

In step c.), the amount for introduction of the homogeneous dispersion or of the hydrogel of the soil conditioner which is needed for soil cultivation is introduced by means of the introduction apparatus to the soil depth region required for soil cultivation.

The amount for introduction necessary for soil cultivation depends here on the properties of the soil area for cultivation and on the type of soil conditioner. Preference is given in accordance with the invention to an amount for introduction, calculated on the basis of dry polymer granules, more preferably those granules obtainable under the Stockosorb® brand of 10 to 50 g/m², preferably 20 to 40 g/m², per unit area of vegetation to be treated. In an embodiment particularly preferred in accordance with the invention the annual amount for introduction for the vegetation area to be cultivated in the case of use of Stockosorb® granules is 30 g/m², or, in the case of use of a mixing ratio of, for example, 1:80, this corresponds to an amount of dispersion or hydrogel of 0.8 to 4.0 l/m².

This present invention further provides an apparatus system for soil cultivation, especially of green areas and existing vegetation areas, which comprises
a.) vessel with stirrer apparatus
b.) dispersant and hydrogel feeds
c.) delivery apparatus
d.) introduction apparatus,
   as has been described above for implementation of the method according to the invention.

The method and apparatus system according to the invention is advantageously suitable for cultivating green areas and vegetation areas, especially lawns of any kind, for example, of green areas and park areas, sports pitches, horseracing tracks, and golf courses, etc.

It was thus completely surprising that the incorporation of water-swellable soil conditioners, for example Stockosorb®, which was found to be exceptionally difficult in dry form, can now be incorporated homogeneously into existing vegetation areas, which prevents a change in the original relief of the vegetation areas. Furthermore, after application of such water-swellable soil conditioners, especially to golf areas and all other lawn areas, the areas after application of these compositions could be played upon again immediately, which leads to a significant extension of the application spectrum of these otherwise very advantageous soil conditioners.

It is also particularly advantageous that, with the method and apparatus system according to the invention, a permanent increase in the useful water capacity of soils and in the plant-available amount of water is ensured in an exceptional manner in the cultivation of green areas, especially in dry regions, and leads to a significant reduction in the irrigation frequency. At the same time, a homogeneous water supply to the plants and more rapid and better root formation are ensured, including a reduction in the nutrient discharge into the groundwater. It is evident that this brings about a great reduction in cost for irrigation and fertilization, which takes account of the scarcity of the water resource, especially in dry regions.

A further advantage of the method and apparatus system according to the invention is that the soil conditioner can be introduced especially in the form of a dispersion or of a hydrogel without sludge deposits in the lower region of the soil to be cultivated, which prevents closure of the undersoil as a result of excessively watery injections, as described, for example, in the cultivation method according to EP 0 627 158.

The examples which follow serve for further illustration of the method and apparatus according to the invention:

### Equipment:

2 water feeds
1 high-pressure apparatus, at at least 100 bar and flat jet nozzle (cold unit),
1 vessel of 300 to 600 liters with stirrer, which is mounted on a vehicle so as to be suitable for lawns, in order to function as a complete delivery vehicle, or which, together with the pressure apparatus, is mounted on a movable carrier as a complete system, or can be utilized as a complete unit for the process according to the invention.

### 1. Production of the Deliverable Application Form of the Soil Conditioner

3 kg of Stockosorb® 500 medium/micro (1:100) or a portion thereof are homogenized with intensive stirring in a 300 l vessel with a stirrer which has been initially charged with 100 l of water. In addition to the stirrer, the use of a high-pressure apparatus is advantageous for the stirring operation, in order to ensure reliable homogenization of the dispersion or of the hydrogel of the soil conditioner for use.

During the stirring and mixing operation, the further amount of water required or the remaining amount of Stockosorb® polymer is fed into the vessel, in order to obtain the desired mixing ratio of the dispersion or of the hydrogel for the selected amount for introduction for the lawn to be cultivated. The amount for introduction here is 30 g/l, based on the defined vessel volume.

### 2. Step b.)

After the production of the homogeneous dispersion of the soil conditioner, which is present in the form of a hydrogel in the case of use of Stockosorb®, this hydrogel is delivered directly with constant stirring and use of a pump to a soil injection unit, which introduces the dispersion or the hydrogel of the soil conditioner to the required soil depth.

### 3. Step c.)

The aforementioned soil injection unit is then used, by means of the injection nozzles, to introduce the soil conditioner into the vegetation area for cultivation, by introducing 15 g/m² into the soil in a separation of 5×7 cm with the soil injection unit being passed over, the unit ensuring at least 300 injection sites per m². A second passage, which should be effected exactly crosswise, can double the desired amount of Stockosorb® without damaging the existing vegetation area, i.e. the total amount for introduction of 30 g/m² is then introduced and distributed into the soil down to the desired depth as set with the nozzles.

The method according to the invention thus allows the amount for introduction of the soil conditioner and the distribution thereof into the soil to be defined exactly. This is necessary in order to take account of the different soil conditions and climatic conditions of the particular vegetation areas for cultivation.

Finally, after introduction of the water-swellable soil conditioners into the soil, the equipment used should be cleaned immediately, since the cleaning would unnecessarily be made more difficult by the swelling properties of the polymers used.

The introduction technique for water-swellable soil conditioners that is described here is particularly advantageous since it ensures homogeneous water absorption and water release and stabilizes the injection cavities which form in the course of introduction of the compositions. This ensures especially that, in the event of prolonged stress and dry periods, optimal plant growth is ensured, and the esthetic appeal of high-quality vegetation areas such as green areas (landscaping, golf and sports areas, recreation areas) can be maintained.

1. A method of soil cultivation, comprising:
a.) producing a deliverable application form of a soil conditioner, wherein the soil conditioner is present as at least one of a dispersion of pre-swollen particles and a hydrogel,
b.) delivering the application form of the soil conditioner produced in a.) to an introduction apparatus,
c.) introducing the soil conditioner by the introduction apparatus.

2. The method according to claim 1, wherein the deliverable application form of the soil conditioner is produced by a mixing apparatus.

3. The method according to claim 1, wherein the deliverable application form of the soil conditioner is a homogeneous dispersion or a hydrogel of the soil conditioner.

4. The method according to claim 1, wherein the soil conditioner is a water-swellable.

5. The method according to claim 1, wherein the particle size of the water-swellable polymer is in the range of 0.2 to 3 mm.

6. The method according to claim 1, wherein the water-swellable polymer is obtained by polymerizing:
a.) 55 to 99.95% by weight of monomers which bear monoethylenically unsaturated carboxyl groups and are optionally partially neutralized
b.) 0.05 to 5.0% by weight of at least one crosslinker,
c.) 0 to 40% by weight of further monomers copolymerizable with a.), and
d.) 0 to 30% by weight of a water-soluble grafting base, wherein the sum of a.) to d.) is 100% by weight.

7. The method according to claim 1, wherein the water-swellable polymer is surface postcrosslinked at least once.

8. The method according to claim 1, wherein the homogeneous emulsion and/or dispersion of the soil conditioner is delivered by a delivery apparatus to an introduction apparatus, or within the latter.

9. The method according to claim 1, wherein the delivery apparatus is a pump and/or a pump system.

10. The method according to claim 1, wherein the introduction apparatus introduces the soil conditioner to a depth of 3 to 25 cm.

11. The method according to claim 10, wherein the introduction apparatus comprises a pressure apparatus in the form of an injection unit to introduce the soil conditioner into the soil.

12. The method according to claim 1, wherein the soil conditioner is introduced into the soil in the form of a hydrogel.

13. An apparatus system for soil cultivation obtained by the method according to claim 1.

14. The apparatus system for soil cultivation according to claim 13, comprising:
a.) a vessel with stirrer apparatus;
b.) emulsion and dispersant feeds;
c.) a delivery apparatus; and
d.) an introduction apparatus.
